(19) United States
(12) Patent Application Publication
(10) Pub. No.: US 2012/0176358 A1
(43) Pub. Date: Jul. 12, 2012

(54) DISPLAY DEVICE, COMPUTER PROGRAM, STORAGE MEDIUM, AND IMAGE DISPLAYING METHOD

(76) Inventors: Eiichi Kaji, Hakusan-shi (JP); Takahiro Kono, Hakusan-shi (JP)

(21) Appl. No.: 13/497,696

(22) PCT Filed: Jul. 15, 2010
(86) PCT No.: PCT/JP2010/062000

§ 371 Date: Mar. 22, 2012

(30) Foreign Application Priority Data
Oct. 20, 2009 (JP) 2009-241528

(51) Int. Cl. G09G 5/00

(52) U.S. Cl. 345/207

(57) ABSTRACT

Provided are a display device, a computer program, a storage medium, and an image displaying method, which are capable of adjusting a light intensity of a display panel without using a photometric image. An optical sensor 5 measures the light intensity (tristimulus value) from a partial display area of a display panel (1) (measurement area of the display panel measured by the optical sensor (5)), and the partial display area has multiple pixels. A computation unit (20) computes the luminous intensity (tristimulus value) emanating from the measurement area based on a video level (image data) of each pixel for displaying an image in the measurement area. A comparison unit (19) compares the computed light intensity with the measured light intensity. A control unit (10) adjusts the light intensity (luminance, chromaticity, or the like) of the display panel (1) based on a comparison result by the comparison unit (19).

### CROSS-REFERENCE TO RELATED APPLICATIONS

This application is a National Phase of PCT International Patent Application No. PCT/JP2010/062000, filed Jul. 15, 2010, which claims priority benefit to Japanese Patent Application No. 2009-241528, filed Oct. 20, 2009, in the Korean Intellectual Property Office, the disclosures of which are incorporated herein by reference.

### BACKGROUND OF THE INVENTION

1. Field of the Invention

The present invention relates to a display device that is capable of adjusting light intensity of a display panel that displays an image, to a computer program for adjusting the light intensity, to a storage medium that stores the computer program, and to an image displaying method.

2. Description of the Related Art

A display device having a display panel (such as a liquid crystal panel) controls a transmittance amount of light from a backlight, which is provided on a back side thereof, by changing a light transmittance ratio for each pixel of the liquid crystal panel. Thus, the display device displays tone of the image. The light transmittance ratio of the liquid crystal panel may become off a designed value due to the manufacturing variations of the display device, and thereby the desired tone characteristics may not be obtained. For the countermeasure for the above, a memory or the like may store an LUT (lookup table), in which tone levels (tone value) based on a received image signal are associated with corresponding input levels to the liquid crystal panel. Then, the tone level is converted into the input level based on the LUT in order to correct unique tone characteristics of each display device so that the desired tone characteristics are achieved.

However, the characteristics of the liquid crystal panel, the backlight, or the like may change across the ages during the usage of the display device. When the aging occurs, it may be impossible to achieve the desired tone characteristics even after the correction of the tone characteristics based on the LUT stored during the production or the shipping of the display device. The user may require different chromaticity, luminance, or tone characteristics of the screen for different usage of the display device. In order to countermeasure these problems, the user is capable of dealing with the problems by updating the LUT (in other words, by executing the calibration) after the shipping of the display device. Since it is necessary to measure actual display characteristics (luminous intensity) of the display device during the execution of the calibration, the display device is provided with a sensor for the measurement.

For example, a display adjusting device is disclosed as below (see Patent Document 1). In the display adjusting device, test pattern data is set as image data, and multiple color data sets including those of black and white are sequentially displayed in a predetermined area of a screen surface of the display. Analog signals outputted from a monochrome sensor are converted into digital signals. Then, the converted digital signals are processed based on prepared standard data, and data in the lookup table is changed based on the above process results in order to facilitate the adjustment of color, luminance, and contrast of the display.

### PRIOR ART REFERENCE

### Patent Document

Patent Document 1: JP-A-Hei9-97044

### SUMMARY OF THE INVENTION

However, in the device of Patent Document 1, it is needed to make the photometric image in advance, and to display the photometric image in a predetermined area of the screen of the display. Therefore, when the measurement work, such as calibration, is executed, the photometric image overlaps the originally displayed image, and thereby disadvantageously obstructing the work of the user.

The present invention is made in view of the above circumstances, and provides a display device that is capable of adjusting a light intensity of display panel without using a photometric image, a computer program for adjusting the light intensity, a storage medium that stores the computer program, and an image displaying method.

A display device according to a first invention, having a display panel that displays an image, includes a measurement unit, a computation unit, a comparison unit, and an adjustment unit. The measurement unit measures a light intensity from a partial display area of the display panel, and the partial display area has a plurality of pixels. The computation unit computes the light intensity emanating from the display area based on image data for displaying an image in the display area. The comparison unit compares the light intensity computed by the computation unit with the light intensity measured by the measurement unit. The adjustment unit adjusts the light intensity of the display panel based on a comparison result by the comparison unit.

A display device according to a second invention further includes, in the first invention, a pixel intensity computation unit that computes the light intensity emanating from each of the pixels in the display area based on the image data for displaying the image in the display area. The computation unit is configured to compute the light intensity based on a value computed by summing the light intensity, which is computed by the pixel intensity computation unit, of each of the pixels in the display area.

A display device according to a third invention further includes, in the second invention, a weighting unit that weights the light intensity, which is computed by the pixel intensity computation unit, according to each of the pixels in the display area. The computation unit is configured to compute the light intensity based on a value computed by summing the light intensity, which is weighted by the weighting unit, of each of the pixels in the display area.

A display device according to a fourth invention is characterized in that, in the third invention, the weighting unit is configured to weight the light intensity based on a distance of each of the pixels in the display area from the measurement unit.

A display device according to a fifth invention is characterized in that, in the fourth invention, the weighting unit is configured to weight the light intensity based on an angle formed between each of the pixels in the display area and the measurement unit.

A display device according to a sixth invention is characterized in that, in any one of the first invention to the fifth invention, the measurement unit is located at a position where the measurement unit is prevented from overlapping a screen of the display panel.

A display device according to a seventh invention is characterized in that, in any one of the first invention to the sixth invention, the light intensity includes at least one of luminance and chromaticity.

In a computer program according to an eighth invention, a computer program for adjusting a light intensity from a display panel that displays an image causes a computer to execute steps of measuring a light intensity from a partial display area of the display panel, computing the light intensity emanating from the display area based on image data for displaying an image in the display area, comparing the computed light intensity with the measured light intensity, and adjusting the light intensity of the display panel based on a comparison result at the comparing step.

A computer-readable storage medium according to a ninth invention stores the computer program according to the eighth invention.

In an image displaying method according to a tenth invention, an image displaying method of a display device having a display panel that displays an image includes steps of measuring a light intensity from a partial display area of the display panel by using a measurement unit, the partial display area having a plurality of pixels, computing the light intensity emanating from the display area based on image data for displaying an image in the display area, comparing the computed light intensity with the measured light intensity, and adjusting the light intensity of the display panel based on a comparison result at the comparing step by using an adjustment unit.

In the first invention, the eighth invention, the ninth invention, and the tenth invention, the measurement unit (for example, an optical sensor or the like) measures the light intensity from the partial display area in the display panel (the measurement area in the display panel measured by the optical sensor). The partial display area has multiple pixels. The computation unit computes the light intensity emanating from the display area based on image data for displaying an image in the display area. The comparison unit compares the computed light intensity with the measured light intensity, and the adjustment unit adjusts the light intensity of display panel based on a comparison result by the comparison unit. In other words, without using the photometric image, the light intensity, which is emanating from the display area, is computed as the ideal value or as the target value, from the image data that corresponds to the image (image that is different from the photometric image) displayed in the partial display area (measurement area) within the image displayed on the display panel. By comparing the computed light intensity with the light intensity, which is obtained through the actual measurement of the light from the display area, adjustment is made such that the actual light intensity becomes closer to the ideal value or the target value. Due to the above, since it is not required to display the photometric image or the photometric pattern on the display panel, the original display image is not overlapped by the photometric image or the like, it is possible to use 100% of the entire screen of the display panel, and thereby improving the workability of the user.

In the second invention, the pixel intensity computation unit computes the light intensity emanating from each of the pixels in the display area based on image data for displaying the image in the display area. The computation unit computes the light intensity based on the value obtained by summing the light intensity computed by the pixel intensity computation unit for each of the pixels in the display area. The value obtained by summing the light intensity for each pixel in the display area is computed as the light intensity in the display area. As a result, even when the tone of the image displayed in the display area is uneven, or even when the image has a patchy pattern, it is possible to stably obtain the light intensity of the whole display area just by displaying the actual image that is different from the photometric image.

In the third invention, the weighting unit weights the light intensity computed by the pixel intensity computation unit according to each of the pixels in the display area. For example, if the degree of the light intensity changes according to the position of each pixel in the display area when the light intensity from the display area is measured, the weighting is executed based on the position information of each pixel in the display area. The computation unit computes the light intensity based on the value which is obtained by summing the light intensity weighted by the weighting unit for each of the pixels in the display area. Due to the above, it is possible to compute the light intensity in the display area based on the position relation between the measurement unit (for example, the optical sensor) and the display area.

In the fourth invention, the weighting unit executes the weighting based on the distance of each pixel of the display area from the measurement unit (for example, the optical sensor). The influence of the output of the pixel in the display area over the measured value by the measurement unit becomes smaller with the increase of the distance from the measurement unit. Thus, by executing the weighting based on the degree of the influence over the measured value, it is possible to accurately compute the light intensity of the display area.

In the fifth invention, the weighting unit executes the weighting based on the angle formed between each pixel of display area and the measurement unit (for example, the optical sensor). Theoretically, the display panel has some parts, which are not normally visible when observed in a tilted manner relative to the screen. More specifically, luminance may decrease or a specific color may become hard to see with the increase of the angle relative to the front surface of the liquid crystal panel. In other words, the influence of the output of the pixel in the display area over the measured value by the measurement unit becomes smaller with the decrease of the angle formed among each pixel, the measurement unit, and the display panel surface. Therefore, it is possible to accurately compute the light intensity of the display area by executing the weighting based on the degree of the influence over the measured value.

In the sixth invention, the measurement unit is provided at a position where the measurement unit is prevented from overlapping the screen of the display panel. Due to the above, it is possible to prevent the measurement unit from overlapping the part of the display panel. As a result, it is possible to use 100% of the entire screen of the display panel, thereby improving workability of the user.

In the seventh invention, the light intensity includes at least one of the luminance and the chromaticity. Due to the above, it is possible to adjust at least one of the luminance and the chromaticity without using the photometric image or the photometric pattern.

According to the present invention, since it is not required to display a photometric image or a photometric pattern on the display panel, an image displayed for the work of the user is not overlapped by the operation for measurement of light or color. As a result, the work of the user is not obstructed, and thereby it is possible to, on a real time basis or arbitrarily, execute measurement of light or color. Thus, it is possible to improve workability of the user, and also to always provide stable display.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a front view illustrating an appearance of a display device according to a present embodiment.

FIGS. 2(a) and 2(b) are schematic cross-sectional views illustrating a configuration of the display device according to the present embodiment.

FIG. 3 is a block diagram illustrating the configuration of the display device according to the present embodiment.

FIG. 4 is an explanatory diagram illustrating one example of weighting a light intensity of the present embodiment.

FIG. 5 is a flow chart illustrating a process procedure of an image displaying method of the present embodiment.

FIG. 6 is a schematic cross-sectional view illustrating a configuration of a display device according to a second embodiment.

FIG. 7 is a schematic cross-sectional view illustrating a configuration of a display device according to a third embodiment.

FIG. 8 is a schematic cross-sectional view illustrating a configuration of display device according to a fourth embodiment.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

### First Embodiment

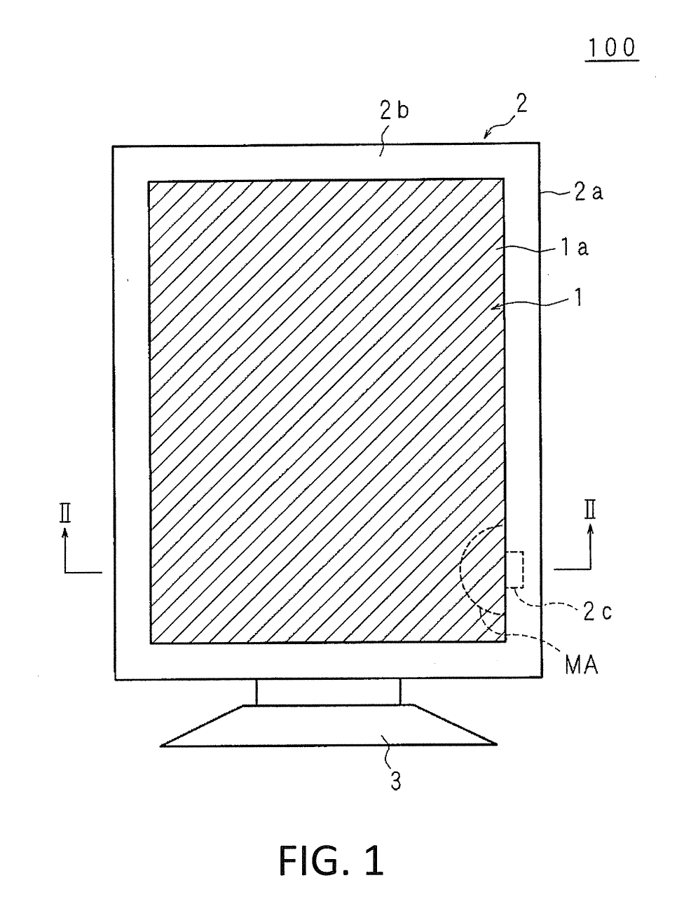

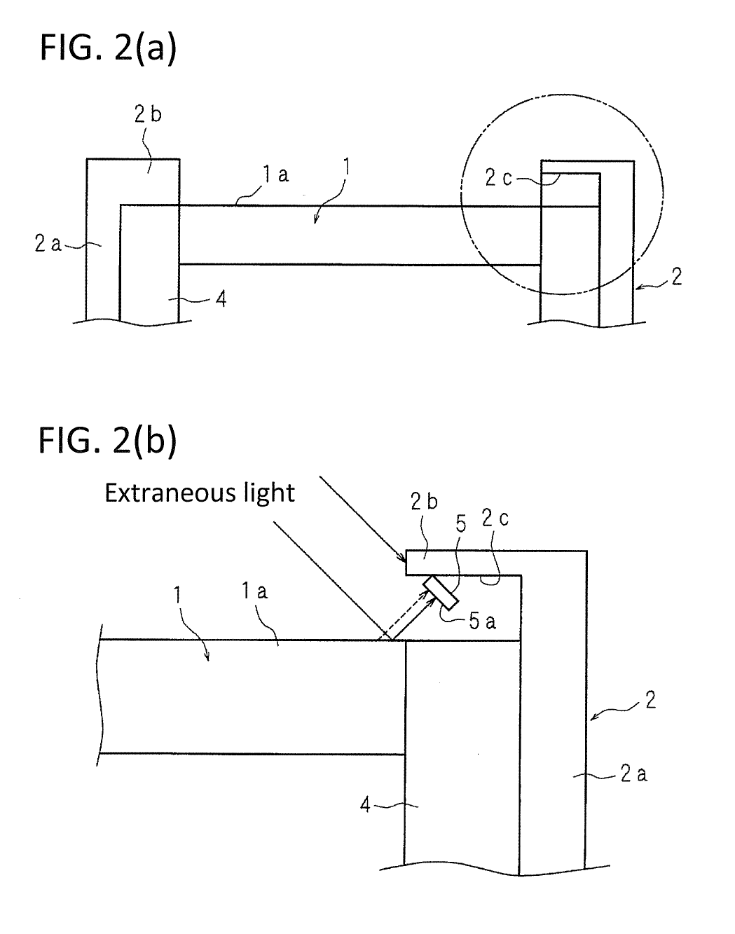

A display device, a computer program, a storage medium, and an image displaying method according to the present invention will be descried below with reference to drawings illustrating an embodiment. FIG. 1 is a front view illustrating an appearance of a display device 100 according to the present embodiment, and FIGS. 2(a) and 2(b) are schematic cross-sectional views illustrating a configuration of the display device 100 according to the present embodiment. FIGS. 2(a) and 2(b) illustrate cross-sectional views taken along a line II-II in FIG. 1, and FIG. 2(b) shows an enlarged view of an encircled part by a dashed and double-dotted closed-curved line in FIG. 2(a).

The display device 100 of the present embodiment includes a display panel 1 (such as a liquid crystal panel, or the like). The display device 100 has a main body part, which has a generally rectangular plate shape, and is provided with a rectangular screen 1a of the display panel 1 at the front (front surface) of the main body part. The screen 1a is capable of displaying various images, such as a monochrome image or a color image. The main body part of the display device 100 is supported by a stand 3, which is fixed at the back of the main body part of the display device 100, such that the screen 1a stands generally perpendicularly to a desk surface, a floor surface, or the like.

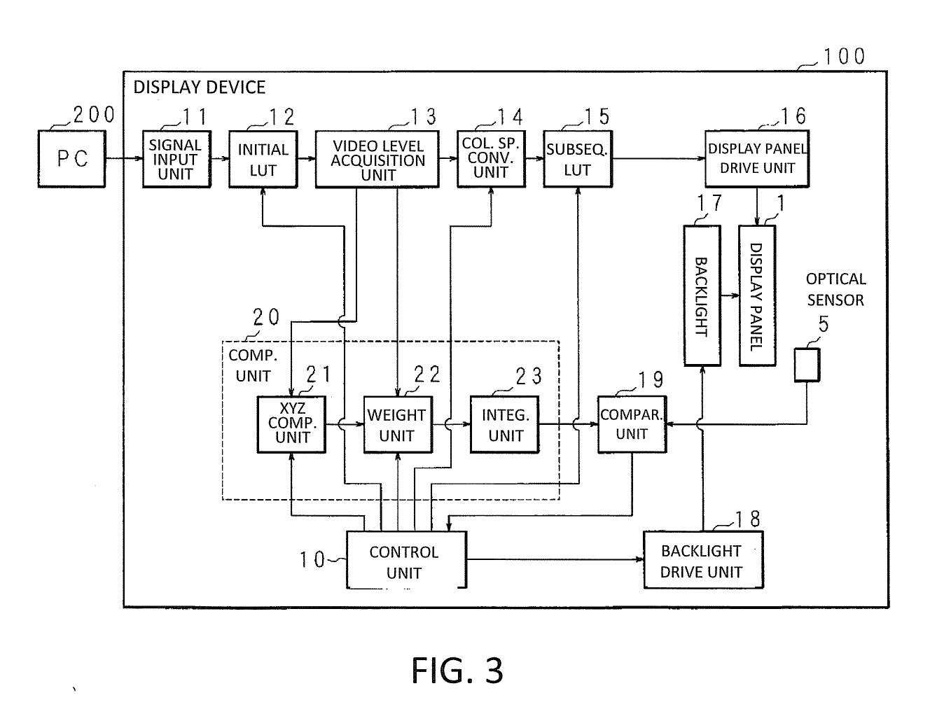

The main body part of the display device 100 has a synthetic resin or metal casing 2 that receives therein the display panel 1, a later-described backlight 17 (see FIG. 3), circuit boards (not shown), and the like. The casing 2 is dividable into multiple components, and these components include, for example, a framing member (bezel frame) 2a, which is attached to a front side of the display device 100, and a back member 2b, which is attached to a back side of the display device 100. The back member 2b has a generally rectangular flat container shape, and receives therein the display panel 1, the backlight 17, the circuit boards (not shown), and the like.

The casing 2 receives therein a metal or synthetic resin chassis 4, which has a generally rectangular flat container shape smaller than the back member 2b of the casing 2. The chassis 4 supports a peripheral edge of the display panel 1, which has a generally rectangular plate shape, by an opening portion of the chassis 4. The chassis 4 immovably fixes the display panel 1 in a manner that the screen 1a is visible from a front side of the display device 100. Also, the chassis 4 receives therein the backlight 17 on a back side of the display panel 1. The backlight 17 may be a CCFL (Cold Cathode Fluorescent Lamp), an LED (Light Emitting Diode), or the like. Furthermore, the chassis 4 receives therein an optical member that reflects or spreads the light from the backlight 17 in order to emanate the light toward the back surface of the display panel 1.

The chassis 4, which supports the display panel 1 and receives therein the backlight 17, circuit boards, or the like, is received within the back member 2b of the casing 2 of the display device 100. The chassis 4 is formed to have a length (thickness) such that the chassis 4 slightly projects from an opening portion of the back member 2b when the chassis 4 is received within the back member 2b. Thus, by attaching the framing member 2a of the casing 2 to the back member 2b, it is possible to fix the chassis 4 within the casing 2.

The framing member 2a has a rectangular frame shape having a generally rectangular opening portion, and has a width for covering the chassis 4 that surrounds the display panel 1 when the framing member 2a is attached to the back member 2b. Due to the above, when the framing member 2a is attached to the back member 2b, the framing member 2a surrounds the display panel 1 in a manner the framing member 2a does not cover the screen 1a of the display panel 1 and that the screen 1a is visible from the opening portion of the framing member 2a. In FIGS. 2(a) and 2(b), although there is nothing provided at the opening portion of the framing member 2a, the framing member 2a may be configured to have a light transparent material, which covers the opening portion of the framing member 2a, for dust proofing or the like.

In a state, where the back member 2b of the casing 2 receives therein the chassis 4 and the framing member 2a is attached, the framing member 2a projects forward (or toward the front side) from the screen 1a of the display panel 1, which is fixed to the chassis 4.

The framing member 2a has an inner surface, on which a recess 2c having a suitable size is formed at a lower-right position in a front view of the display device 100. The recess 2c is formed such that a front side surface of the chassis 4 is visible. Although there is nothing provided to the opening portion of the recess 2c in FIGS. 2(a) and 2(b), for dust proofing, the opening portion of the recess 2c may be alternatively covered by a light transparent material. The shape, the size, and the position of the recess 2c are not limited to the example shown in FIG. 1, but are determined appropriately in consideration of the usage environment of the display device 100, a size of a measurement area MA at an optical sensor 5, influence by the light from the display panel 1 and extraneous light (ambient light), or the like. Ambient light is light related to the usage environment of the display device 100.

The optical sensor 5 is provided within the recess 2c and measures a luminous intensity of a partial display area (measurement area MA) of the display panel 1. In the above, the partial display area includes multiple pixels. The optical sensor 5 has a light receiving surface 5a, and measures an intensity of light (for example, luminance, chromaticity, or the like) received by the light receiving surface 5a. Then, the optical sensor 5 outputs electric signals based on measurement results. Also, the optical sensor 5 is provided within the recess 2c in a state where the light receiving surface 5a is tilted relative to the screen 1a of the display panel 1 by a predetermined angle (for example, 45°), so that the light receiving surface 5a faces the screen 1a. Note that the angle, by which the optical sensor 5 is tilted relative to the screen 1a, may be determined as required based on a view angle of the display panel 1, a size of the recess 2c, a size of the optical sensor 5, etc.

Since the light receiving surface 5a of the optical sensor 5 is designed to face the screen 1a of the display panel 1 in a tilted state within the recess 2c, the optical sensor 5 is capable of receiving light outgoing from the screen 1a of the display panel 1 (see the dashed line arrow in FIG. 2(b)) by using the light receiving surface 5a. The optical sensor 5 is also capable of receiving reflected light, which is the light from the exterior of the display device 100 reflected on the screen 1a of the display panel 1 (see the solid line arrow in FIG. 2(b)). In practice, the outgoing light from the screen 1a of the display panel 1 is the light, which is emanating from the backlight 17 of the display device 100, and which transmits through the display panel 1. Also, the light from the exterior of the display device 100 may be sunlight or may be luminous light of a room, in which the display device 100 is installed.

Also, since the optical sensor 5 is provided within the recess 2c of the framing member 2a and since the light receiving surface 5a is tilted to face the screen 1a of the display panel 1, light from the exterior of the display device 100 does not directly enter the light receiving surface 5a of the optical sensor 5 (or, light, which is not reflected on the screen 1a, does not enter the light receiving surface 5a). Even in a case where extraneous light enters the light receiving surface 5a, the amount of the entering extraneous light is sufficiently small compared with light from the display panel 1 and light reflected on the screen 1a. As a result, the optical sensor 5 does not directly receive the extraneous light, but is capable of receiving the outgoing light from the display panel 1 and the extraneous light reflected on the screen 1a.

FIG. 3 is a block diagram illustrating a configuration of the display device 100 according to the present embodiment. The display device 100 includes a control unit 10, a signal input unit 11, an initial LUT (lookup table) 12, a video level acquisition unit 13, a color space conversion unit 14, a subsequent LUT (lookup table) 15, a display panel drive unit 16, the backlight 17, a backlight drive unit 18, a comparison unit 19, a computation unit 20, the display panel 1, the optical sensor 5, or the like. Also, the computation unit 20 includes an XYZ computation unit 21, a weighting unit 22, an integration unit 23, or the like. The display device 100 is connected to an external PC (personal computer) 200 through a signal line.

The signal input unit 11 has a connection terminal that is connected to external equipment (such as the PC 200) through a cable, and obtains video signal received from the PC 200. The signal input unit 11 outputs the obtained video signal to the initial LUT 12. The video signal, which is inputted into the signal input unit 11 from the PC 200, may be either an analog signal or a digital signal.

The initial LUT 12 has LUTs that correspond to each of R (red), G (green), and B (blue), for example. In the LUTs, the input tone indicated by the inputted video signal is associated with the corresponding input level (output value) to the display panel 1 (more precisely, the subsequent LUT 15). The initial LUT 12 has the 8-bit input tone and the 14-bit output tone (output value), for example. The 14-bit output tone is stored in one of the 256 entries that correspond to 256 tones (from 0 to 255), for example. Thus, the user is capable of setting tone characteristics (such as, setting of the gamma value) to achieve desired tone characteristics.

The video level acquisition unit 13 obtains a video level F (V_R, V_G, V_B) of each of the pixels in the measurement area MA (partial display area). The measurement area MA is a part of the screen 1a of the display panel 1, and light intensity of the measurement area MA is measured by the optical sensor 5. The video level acquisition unit 13 outputs the obtained video level F to the XYZ computation unit 21. Note that the video levels F (V_R, V_G, V_B) correspond to the respective video signals R (red), G (green) and B (blue).

The video level acquisition unit 13 obtains position information of each of the pixels (for example, a coordinate value of the pixel, or the like) in the measurement area MA, and outputs the obtained position information to the weighting unit 22.

The color space conversion unit 14 adjusts the output value (output tone) outputted from the initial LUT 12, for example, by using a 3 3 matrix (color conversion matrix D) made of conversion coefficients that correspond to R, G, B components so that the color space conversion unit 14 adjusts the color by emphasizing or de-emphasizing a specific color component. Then, the color space conversion unit 14 outputs the adjusted output tone (output value) to the subsequent LUT 15. The color space conversion unit 14, under control of the control unit 10, uses the color conversion matrix D to adjust chromaticity, which is one of the light intensity emanating from the display panel 1.

The subsequent LUT 15 includes LUTs that correspond to respective R (red), G (green) and B (blue), for example, and corrects the output tone in order to cause the tone characteristics, which is different for the different display panel 1, to be an ideal gamma value (post-gamma, 2.2, for example) to achieve the smooth tone display. Then, the subsequent LUT 15 outputs the corrected output tone (correction signal) to the display panel drive unit 16.

The display panel drive unit 16 is provided with a gate driver, a source driver, or the like, and drives the display panel 1 based on the correction signal inputted from the subsequent LUT 15 under control of the control unit 10.

The display panel 1 is a liquid crystal panel, for example, and has a pair of glass substrates provided to face each other. The display panel 1 has a liquid crystal layer, which serves as a liquid crystal substance, formed between the glass substrates. One of the glass substrates is provided with multiple pixel electrodes and TFTs, each drain of which is connected to each of the pixel electrodes. The other one of the glass substrates is provided with a common electrode. A gate and a source of each TFT are connected to each output stage of the respective gate and source drivers sequentially.

In the display panel 1, the TFT of each pixel is turned on and off based on a gate signal received from the gate driver. An output voltage (input level to the display panel 1) received from the source driver is applied to the TFT of each pixel during the ON period. Thus, the light transmittance ratio, which is determined by the electric optical characteristics of the liquid crystal substance, is controlled to display the tones of the video. The display panel 1 is held between a pair of polarizing plates, and has the backlight 17 provided at the back thereof.

The backlight drive unit 18 is controlled by the control unit 10 to output a drive signal (bright value) to the backlight 17. Due to the above, the backlight drive unit 18 is capable of adjusting light emanating from the backlight 17. In other words, the backlight drive unit 18 is capable of adjusting the luminance, which is one of the light intensity of the display panel 1.

The optical sensor 5 includes three sensors that has spectral sensitivity generally identical with spectral sensitivity of human eyes, for example, and is capable of measuring three values of X, Y, Z, which are named as tristimulus values. The optical sensor 5 measures the light intensity of the measurement area MA of the screen 1a of the display panel 1, and outputs the measured values Xsns, Ysns, Zsns to the comparison unit 19.

The computation unit 20 includes the XYZ computation unit 21 that functions as a pixel intensity computation unit. The XYZ computation unit 21 computes the intensity of light emanating from each of the pixels in the measurement area MA based on the video level F that corresponds to image data for displaying an image (image different from a photometric image or a photometric pattern) in the measurement area MA.

More specifically, the XYZ computation unit 21 obtains, from the control unit 10, a brightness ratio B, a panel chromaticity C, the color conversion matrix D, and a conversion parameter E. The conversion parameter E is used for converting a chromaticity coordinate x, y into tristimulus values X, Y, Z. The XYZ computation unit 21 also obtains, from the video level acquisition unit 13, the video level F of the measurement area MA, and computes the tristimulus values X, Y, Z that serve as the light intensity of each of the pixels in the measurement area MA.

The tristimulus values X, Y, Z are computed by Equation (1). The brightness ratio B, the panel chromaticity C, the color conversion matrix D, the conversion parameter E, and the video level F are also obtained by Equation (1).

$$\begin{matrix}( \begin{matrix}X \\ Y \\ Z\end{matrix} ) = ( \frac{Bnow}{B\_xy} ) ( \begin{matrix}PRx & PGx & PBx \\ PRy & PGy & PBy \\ PRz & PGz & PBz\end{matrix} ) ( \begin{matrix}{M}_{11} & {M}_{12} & {M}_{13} \\ {M}_{21} & {M}_{22} & {M}_{23} \\ {M}_{31} & {M}_{32} & {M}_{33}\end{matrix} ) ( \begin{matrix}Hr & 0 & 0 \\ 0 & Hg & 0 \\ 0 & 0 & Hb\end{matrix} ) ( \begin{matrix}V\_R \\ V\_G \\ V\_B\end{matrix} ) \\ B = ( \frac{Bnow}{B\_xy} ) \\ C = ( \begin{matrix}PRx & PGx & PBx \\ PRy & PGy & PBy \\ PRz & PGz & PBz\end{matrix} ) \\ D = ( \begin{matrix}{M}_{11} & {M}_{12} & {M}_{13} \\ {M}_{21} & {M}_{22} & {M}_{23} \\ {M}_{31} & {M}_{32} & {M}_{33}\end{matrix} ) \\ E = ( \begin{matrix}Hr & 0 & 0 \\ 0 & Hg & 0 \\ 0 & 0 & Hb\end{matrix} ) \\ F = ( \begin{matrix}V\_R \\ V\_G \\ V\_B\end{matrix} ) & Equation ( 1 ) \\ ( \begin{matrix}X \\ Y \\ Z\end{matrix} ) = ( \frac{B\_xy}{B\_xy} ) ( \begin{matrix}PRx & PGx & PBx \\ PRy & PGy & PBy \\ PRz & PGz & PBz\end{matrix} ) ( \begin{matrix}1 & 0 & 0 \\ 0 & 1 & 0 \\ 0 & 0 & 1\end{matrix} ) ( \begin{matrix}Hr & 0 & 0 \\ 0 & Hg & 0 \\ 0 & 0 & Hb\end{matrix} ) ( \begin{matrix}1 \\ 1 \\ 1\end{matrix} ) & Equation ( 2 ) \\ ( \begin{matrix}X \\ Y \\ Z\end{matrix} ) = ( \begin{matrix}PRx & PGx & PBx \\ PRy & PGy & PBy \\ PRz & PGz & PBz\end{matrix} ) ( \begin{matrix}Hr \\ Hg \\ Hb\end{matrix} ) & Equation ( 3 )\end{matrix}$$

In the brightness ratio B, Bnow is an adjustment value outputted in order to set luminance (luminosity) of the backlight 17, and B_xy is a brightness value during the measurement of a panel chromaticity. During the measurement of the panel chromaticity, the equation of Bnow=B_xy is satisfied, and the brightness ratio B becomes 1.

The panel chromaticity C indicates the chromaticity or the like, and corresponds to x, y, z that indicate ratios of the tristimulus values X, Y, Z. Since the color is indicated by a color mixture ratio, the equation of x+y+z=1 (100%) is satisfied. Thus, if x and y are known, z is obtained. Note that x and y are coordinate values in a chromaticity chart.

The color conversion matrix D is used for intentionally emphasizing and de-emphasizing a specific color. When color conversion is not performed, the color conversion matrix D is a diagonal matrix with all diagonal entries of 1.

Each value of the video level F employs a normalized value such that each pixel input level has a maximum value of 1. Equation (1) is used under the assumption that the gamma coefficient satisfies the equation of γ=1 in the stage of and after the video level acquisition unit 13. When the gamma coefficient of the display panel 1 does not satisfy the equation of γ=1, the gamma coefficient needs to be corrected by the subsequent LUT 15. In a case, where correcting means (such as the subsequent LUT 15) is not provided, Equation (1) needs to additionally include a correction parameter that considers a display panel 1 dissatisfying the equation of γ=1.

When the tristimulus values X, Y, Z are computed, only the adjustment value Bnow of the backlight 17 and the video level F dynamically change among the parameters required for the computation. Therefore, it is possible to determine other parameters at the shipping or the calibration of the display device 100, and thereby the other parameters may be stored in a storage unit (not shown), such as an EPROM.

Each of the parameters Hr, Hg, Hb of the conversion parameter E is determinable at the shipping or the calibration of the display device 100. Specifically, when white of the maximum color tone without color conversion is measured after the panel chromaticity C of the display panel 1 is measured, each of the parameters Hr, Hg, Hb is obtainable by using Equation (2). Equation (2) may be further expressed as Equation (3). In the above, X, Y, Z indicate values measured by white of the maximum color tone.

Originally, chromaticities x, y of the panel chromaticity C do not have information of luminance (luminosity). In order to countermeasure the above, X, Y, Z, which serve as information including luminance, are computed by using the brightness ratio B, which serves as information associated with luminance, and the conversion parameter E, which is computed when the equation of B=1 is satisfied.

The weighting unit 22 weights the tristimulus values X, Y, Z (light intensity), which is computed by the XYZ computation unit 21, according to each of the pixels in the measurement area MA. In other words, the weighting unit 22 weights the tristimulus values X, Y, Z for each pixel. The weighting unit 22 obtains the tristimulus values X, Y, Z computed by the XYZ computation unit 21, the video level F, and the like. Furthermore, the weighting unit 22 obtains position information of each of the pixels in the measurement area MA from the video level acquisition unit 13. Also, the weighting unit 22 obtains, from the control unit 10, various parameters (for example, an angle relative to the optical sensor 5, a view angle at the video level, a distance to the optical sensor 5, a rate of decrease from a center section of the display panel 1, etc.).

A coordinate of an arbitrary pixel ij in the measurement area MA is indicated by (i, j), and the tristimulus values of the pixel ij are indicated by Xij, Yij, Zij, respectively. Also, a weighting coefficient that corresponds to the pixel ij is indicated by Kij. The weighting unit 22 computes the weighted tristimulus values of the pixel ij by the respective equations Xij Kij, Yij Kij, Zij Kij. In the above, the weighting coefficient Kij may be set in consideration of the above angle relative to the optical sensor 5, the view angle at the video level, the distance to the optical sensor 5, the rate of decrease from the center section of the display panel 1, etc.

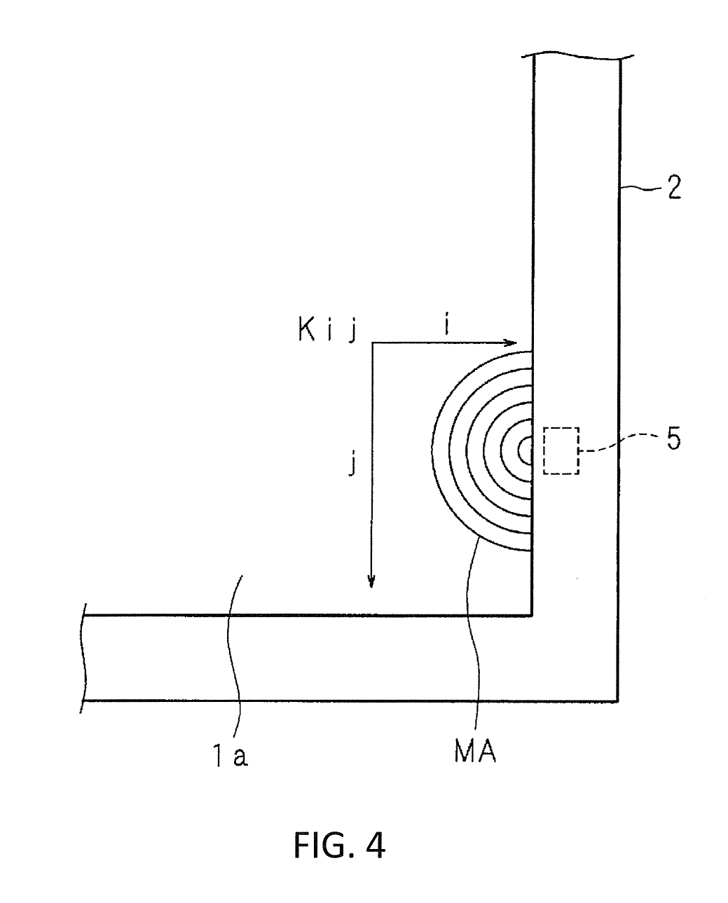

FIG. 4 is an explanatory diagram illustrating one example of weighting the light intensity of the present embodiment. The optical sensor 5 is capable of measuring light emanating from the measurement area MA of the screen 1a. When the distance between each of the pixels in the measurement area MA and the optical sensor 5 increases, the influence of the output of the pixel (light from the pixel) over the measured value of the optical sensor 5 becomes smaller.

Thus, as shown in FIG. 4, the weighting coefficient Kij, which corresponds to the coordinate (i, j) of the pixel in the screen 1a, is determined, and the tristimulus values of each of the pixels in the measurement area MA is weighted according to the weighting coefficient Kij. In the example of FIG. 4, the weighting coefficient Kij is preferably set smaller as the pixel is positioned further away from the optical sensor 5. Note that, in the example of FIG. 4, although the measurement area MA is defined as a semicircle, the shape of the measurement area MA on the screen 1a is not limited to the semicircle, and may be determined according to the position (distance, direction, or the like), types, or the like of the optical sensor 5.

Also, it is possible to execute the weighting in consideration of the view angle in addition to or instead of the consideration of the distance. In other words, since the light receiving surface 5a of the optical sensor 5 is tilted relative to the screen 1a of the display panel 1, the view angle has influence over the measured value, by the optical sensor 5, of the output of the pixel (light from the pixel). Furthermore, since the view angle changes according to the tone of the display panel 1, the weighting may be executed according to the tone when influenced.

The weighting coefficient gets associated with the distance (or the view angle, the tone) and stored in a storage unit (not shown), such as a memory. Then, the weighting coefficient, which corresponds to the distance (or the view angle, the tone) of each pixel, is read from the storage unit. For example, there are prepared a two-dimensional table storing the rate of decrease per the view angle relative to the screen front surface in one direction (for example, 10-degree interval in a horizontal direction) and per the tone (for example, 16-tone interval), and another two-dimensional table storing the rate of decrease per the view angle and per the tone. The weighting is executed based on the view angles relative to the sensor in the horizontal and vertical directions, and the tone to be selected is computed through the interpolation according to the tones. The interpolation process is executed by the linear interpolation, the approximate quadratic interpolation, or the like. A low-priced memory can be used by minimizing the data to be stored, for example, by storing only weighting data for the view angle only in one direction, and weighting data for limited tones.

Alternatively, function for computing the weighting coefficient based on the distance (or the view angle, the tone) may be solely stored in the storage unit (not shown), and the weighting coefficient may be computed instead of storing the weighting data in the storage unit. Also, the weighting coefficient may be provided for each of the pixels in the measurement area MA. Alternatively, the measurement area MA may be divided into multiple partial areas, and the weighting coefficient may be provided for each partial area having multiple pixels therein. In the present embodiment, the light receiving surface 5a of the optical sensor 5 is not provided to face the screen 1a in parallel. Thus, in order to obtain a virtual measured value similar to that of the state, where the light receiving surface 5a faces the screen 1a in parallel, the weighting is executed. Therefore, the level of weighting may be determined as required based on the attachment manner of the optical sensor 5. Also, even in a case, where the light receiving surface 5a of the optical sensor 5 is not provided to face the screen 1a, the weighting process may be omitted provided that the measured value similar to that of the case, where the light receiving surface 5a faces the screen 1a, is equivalently obtained.

The integration unit 23 computes tristimulus values Xtgt, Ytgt, Ztgt (luminous intensity) which serve as target values or ideal values by summing the tristimulus values X, Y, Z (light intensity) of each of the pixels in the measurement area MA, which are weighted by the weighting unit 22. The integration unit 23 outputs the computed tristimulus values Xtgt, Ytgt, Ztgt to the comparison unit 19.

In a situation, where the weighting is not required due to the arrangement or the type of the optical sensor 5, the integration unit 23 may alternatively compute the tristimulus values Xtgt, Ytgt, Ztgt which serve as target values or ideal values by summing the tristimulus values X, Y, Z (light intensity), which is computed by the XYZ computation unit 21, of each of the pixels in the measurement area MA.

The comparison unit 19 compares the computed tristimulus values Xtgt, Ytgt, Ztgt with the measured tristimulus values Xsns, Ysns, Zsns, and computes the differences ΔX (Xtgt−Xsns), ΔY (Ytgt−Ysns), ΔZ (Ztgt−Zsns) of the above values. The comparison unit 19 outputs the computed differences ΔX, ΔY, ΔZ to the control unit 10.

The control unit 10 includes a CPU, a RAM, a ROM, and the like, and is connected to each part within the display device 100 through a bus. The control unit 10 controls operation of each part.

The control unit 10 functions as an adjustment unit that adjusts light intensity of the display panel 1 based on the comparison result of the comparison unit 19. When the difference ΔY computed by the comparison unit 19 is equal to or greater than a predetermined threshold value Brth, the control unit 10 commands the backlight drive unit 18 to adjust luminance (luminosity) of the backlight 17 such that ΔY becomes smaller. In the above case, if the adjustment cycle (cycle of measurement by the optical sensor 5) is set to T (for example, 10 seconds), and the number of adjustment per the adjustment cycle T is set to N (for example, 10 times), only the amount equivalent to ΔY/N is adjusted for one adjustment. Due to the above, it is possible to prevent the user from feeling discomfort because of the rapid change of the luminance (luminosity).

When the difference ΔY computed by the comparison unit 19 is less than the threshold value Brth, the control unit 10 commands the color space conversion unit 14 to adjust the chromaticity of the display panel 1 such that ΔX and ΔZ become smaller. In the above case, if the adjustment cycle (cycle of measurement by the optical sensor 5) is set to T (for example, 10 seconds), and the number of adjustment within the adjustment cycle T is set to N (for example, 10 times), only the amounts equivalent to ΔX/N, ΔZ/N are adjusted for one adjustment. Due to the above, it is possible to prevent the user from feeling discomfort because of the rapid change of the chromaticity (color or tone).

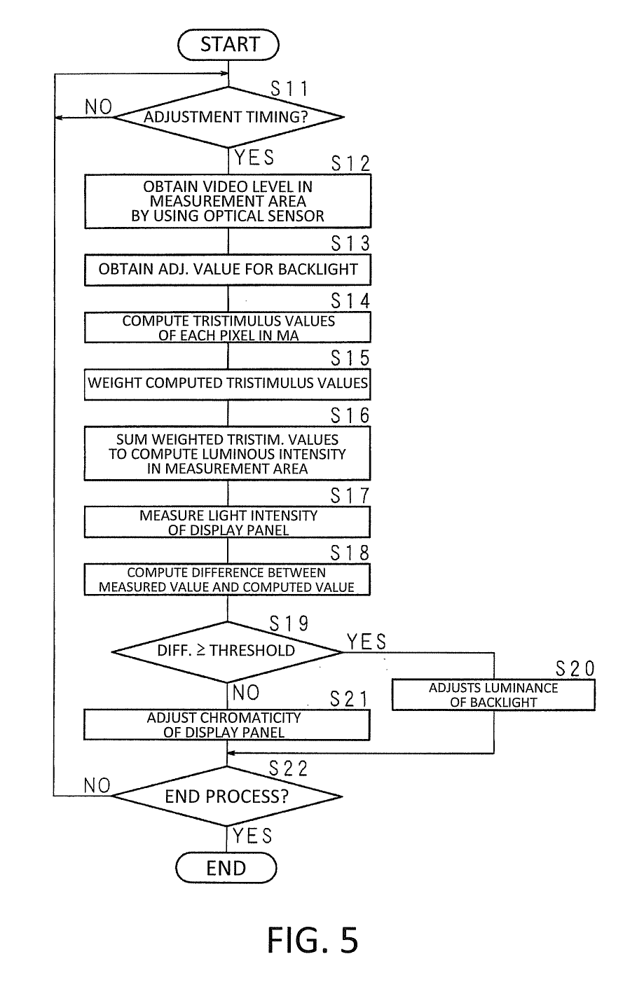

Next, operation of the display device 100 of the present embodiment will be described. FIG. 5 is a flow chart illustrating a process procedure of an image displaying method of the present embodiment. The following process may be achievable by the process executed by the components shown in FIG. 3. Also, the following process may be alternatively achievable in a case, where program codes indicating the process procedure are stored in a storage medium, and the program codes stored in the storage medium are loaded to the RAM to be executed by the CPU. In the description below, the explanation is made in the assumption that the control unit 10 executes the series of processes.

The control unit 10 determines whether it is timing for adjustment (S11). If it is not timing for adjustment (NO at S11), the control unit 10 continues the process of step S11. When it is the timing for adjustment (YES at S11), the control unit 10 obtains the video level F of each of the pixels in the measurement area MA (S12), and obtains the currently set adjustment value of the backlight 17 (S13).

The control unit 10 computes the tristimulus values (light intensity) of each of the pixels in the measurement area MA (S14), and weights the computed tristimulus values (S15). The control unit 10 sums the weighted tristimulus values of each of the pixels in the measurement area MA to compute the luminous intensity (tristimulus values Xtgt, Ytgt, Ztgt) of the measurement area MA (S16).

The control unit 10 measures light intensity (tristimulus values Xsns, Ysns, Zsns) of the display panel 1 in the measurement area MA by using the optical sensor 5 (S17), and computes the differences ΔX, ΔY, ΔZ between the measured values and computed values (S18). The control unit 10 compares the difference ΔY with the threshold value Brth to determine whether the difference ΔY is equal to or greater than the threshold value Brth (S19).

When the difference ΔY is equal to or greater than the threshold value Brth (YES at S19), the control unit 10 adjusts the luminance of the backlight 17 to reduce the difference ΔY (S20). When the difference ΔY is less than the threshold value Brth (NO at S19), the control unit 10 adjusts the chromaticity of the display panel 1 to reduce the differences ΔX, ΔZ (S21).

The control unit 10 determines whether to end the process (S22), and when it is determined not to end the process (NO at S22), the control unit 10 continues the process at and after step S11. When it is determined to stop the process (YES at S22), the control unit 10 stops the process.

As above, in the present embodiment, the optical sensor 5 measures the light intensity (tristimulus values) from the partial display area of the display panel 1 (the measurement area MA in the display panel measured by the optical sensor 5). In the above, the partial display area has the multiple pixels. The computation unit 20 computes the luminous intensity (tristimulus values), which emanates from the measurement area MA, based on the video level (image data) of each pixel for displaying the image in the measurement area MA. The comparison unit 19 compares the computed light intensity with the measured light intensity, and the control unit 10 adjusts the light intensity of the display panel 1 (luminance, chromaticity, or the like) based on the comparison result of the comparison unit 19. In other words, without using the photometric image, the light intensity, which emanate from the measurement area MA, is computed as the ideal value or the target value, from the video level (image data) that corresponds to the image (image different from the photometric image) displayed in the partial measurement area MA within the image displayed on the display panel 1. By comparing the computed light intensity with the light intensity, which is obtained through the actual measurement of the light from the measurement area MA, the luminance or the chromaticity are adjusted such that the actual light intensity becomes closer to the ideal value or the target value. In other words, in the present embodiment, without displaying the photometric image or the photometric pattern, the user is capable of executing the calibration while the image for the work of the user is displayed. Due to the above, since it is not required to display the photometric image or the photometric pattern in the display panel 1, the original display image is not overlapped by the photometric image or the like, it is possible to use 100% of the entire screen of the display panel 1, and thereby improving the workability of the user. In other words, the image displayed for the work of the user is not obstructed by the operation of the measurement of light or color, and thereby the work of the user is not interrupted. As a result, it is possible to, on a real time basis or arbitrarily, execute measurement of the light or the color, and thereby it is possible to always deliver the stable display.

Also, in the present embodiment, the XYZ computation unit 21 computes the light intensity (tristimulus values) emanating from each of the pixels in the measurement area MA based on the video level (image data) for displaying the image in the measurement area MA. The integration unit 23 computes the light intensity (tristimulus values) based on the value obtained by summing the tristimulus values computed by the XYZ computation unit 21 for each of the pixels in the measurement area MA. The value computed by summing the light intensities (tristimulus values), which are computed for each pixel, of the pixels in the measurement area MA is computed as the light intensity (tristimulus values) in the measurement area MA. As a result, even when the tone of the actual image displayed in the measurement area MA is uneven, or even when the image has a patchy pattern, it is possible to stably compute the light intensity in the whole measurement area MA just by displaying the actual image that is different from the photometric image.

In addition to the above, in the present embodiment, the weighting unit 22 weights the tristimulus values, which are computed by the XYZ computation unit 21, according to each of the pixels in the measurement area MA. For example, if the degree of the light intensity changes according to the position of each of the pixels in the measurement area MA when the light intensity from the measurement area MA is measured by the optical sensor 5, the weighting is executed based on the position information of each of the pixels in the measurement area MA. The integration unit 23 computes the light intensity (tristimulus values) based on the values which are obtained by summing the tristimulus values weighted by the weighting unit 22 for each of the pixels in the measurement area MA. Due to the above, it is possible to compute the light intensity in the measurement area MA based on the position relation between the optical sensor 5 and the measurement area MA.

Also, in the present embodiment, the weighting unit 22 executes the weighting based on the distance of each of the pixels in the measurement area MA from the optical sensor 5. The influence of the output of the pixel in the measurement area MA over the measured value by the optical sensor 5 becomes smaller with the increase of the distance from the optical sensor 5. Thus, by executing the weighting based on the degree of the influence over the measured values, it is possible to accurately compute the light intensity of the measurement area MA.

Also, in the present embodiment, the weighting unit 22 executes the weighting based on the angle formed between each of the pixels in the measurement area MA and the optical sensor 5. Theoretically, the display panel 1 has some parts, which are not normally visible when observed in a tilted manner relative to the screen. More specifically, luminance may decrease or a specific color may become hard to see with the increase of the angle relative to the front surface of the liquid crystal panel. In other words, the influence of the output of the pixel in the measurement area MA over the measured value by the optical sensor 5 becomes smaller with the decrease of the angle formed among each pixel, the optical sensor 5, and the display panel surface. Therefore, it is possible to accurately compute the light intensity of the measurement area MA by executing the weighting based on the degree of the influence over the measured value.

Furthermore, in the present embodiment, the optical sensor 5 is provided at a position where the optical sensor 5 is prevented from overlapping the screen 1a of the display panel 1. Due to the above, it is possible to prevent the optical sensor 5 from overlapping the part of the display panel 1. As a result, it is possible to use 100% of the entire screen of the display panel 1, thereby improving workability of the user.

Furthermore, in the present embodiment, the light intensity includes at least one of the luminance and the chromaticity. Due to the above, it is possible to adjust at least one of the luminance and the chromaticity without using the photometric image or the photometric pattern.

Furthermore, in the present embodiment, the computed value and the measured value of the tristimulus values (light intensity) are compared with each other by using the partial area (the measurement area MA) in the image the user actually use, but not by using the special image or pattern for the measurement of the light. Then, the luminance or the chromaticity of the display panel 1 is adjusted based on the comparison result. Therefore, it is possible to always measure the tristimulus values, and thereby to always maintain the stable luminance and chromaticity, greatly improving the quality of the display device 100.

### Second Embodiment

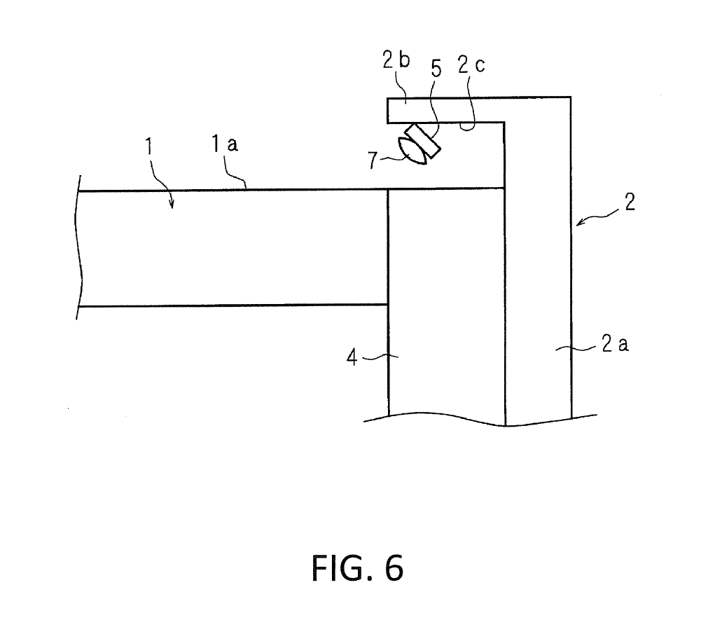

FIG. 6 is a schematic cross-sectional view illustrating a configuration of a display device 100 according to the second embodiment of the present invention. The display device 100 according to the second embodiment has a configuration, where the display device 100 according to the above first embodiment (see FIG. 2(b)) further includes a lens 7 that collects light to the optical sensor 5. The lens 7 may be, for example, a convex lens having projection surfaces formed on both sides of the lens, and may be provided to face the light receiving surface 5a of the optical sensor 5. The lens 7 is provided between the screen 1a of the display panel 1 and the light receiving surface 5a of the optical sensor 5. At the same time, the lens 7 is provided within the recess 2c of the framing member 2a, or in other words, provided outside the screen 1a.

As above, since the lens 7 is provided between the screen 1a of the display panel 1 and the light receiving surface 5a of the optical sensor 5, it is possible to collect outgoing light from the screen 1a and extraneous light reflected on the screen 1a to the light receiving surface 5a of the optical sensor 5. As a result, it is possible to improve the accuracy of measurement by the optical sensor 5, and thereby it is possible to more accurately execute the calibration process of the display device 100. Also, since the lens 7 is provided outside the screen 1a, the lens 7 does not interfere with the image display.

### Third Embodiment

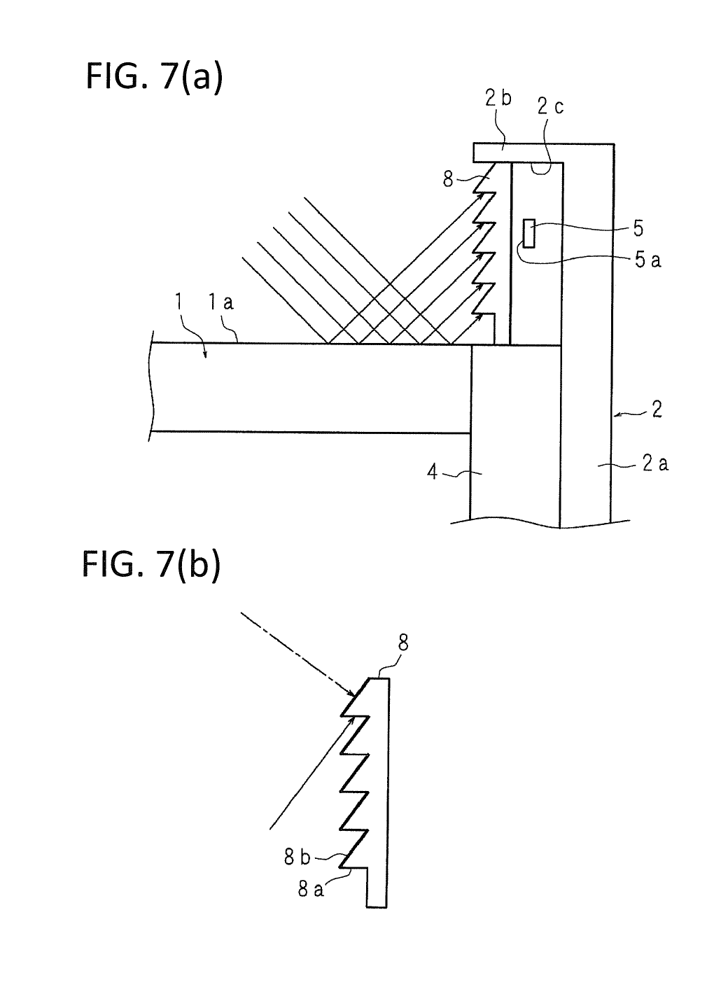

FIGS. 7(a) and 7(b) are schematic cross-sectional views illustrating the configuration of a display device 100 according to the third embodiment of the present invention. FIG. 7(a) shows a configuration of the display device 100 in the vicinity of the optical sensor 5, and FIG. 7(b) shows a configuration of the later-described light guiding member. Similarly to the display device 100 according to the above embodiments, the display device 100 according to the third embodiment has the optical sensor 5 provided within the recess 2c formed at the inner surface of the framing member 2a. However, the display device 100 according to the third embodiment has a light guiding member 8 such that the light guiding member 8 closes the opening of the recess 2c, and the optical sensor 5 is provided such that the light receiving surface 5a faces the light guiding member 8. Also, the light guiding member 8 is provided within the recess 2c so as to be provided outside the screen 1a of the display panel 1.

The light guiding member 8 is an optical member having a serrated cross section. The serrated cross sectional shape has generally triangular protrusions that are regularly arranged. Also, the optical member is made of a translucent material (such as glass or transparent synthetic resin) such that the optical member allows light to transmit therethrough. More specifically, the light guiding member 8 has a plate shape that closes the opening of the recess 2c, and has one flat surface that is provided inside the recess 2c. The light guiding member 8 is provided such that the flat surface faces the light receiving surface 5a of the optical sensor 5. The opposite side surface of the light guiding member 8 has a step shape having generally triangular elongated protrusions in a cross sectional view. The protrusions are formed to extend in the direction along the screen 1a of the display panel 1, and the multiple protrusions are arranged in parallel with the screen 1a.

Each protrusion of the light guiding member 8 has a light collecting surface 8a on one side and a light shielding surface 8b on the other side. The light collecting surface 8a allows light to enter into the light guiding member 8 (or in other words, into the recess 2c). The light shielding surface 8b prevents light. As above, the elongated protrusions of the light guiding member 8, which have the light collecting surfaces 8a and the light shielding surfaces 8b, are arranged stepwise such that the light collecting surfaces 8a and the light shielding surfaces 8b are alternately arranged.

The light collecting surface 8a of the light guiding member 8 is provided to face the screen 1a of the display panel 1, and is provided generally in parallel with the screen 1a. The light shielding surface 8b of light guiding member 8 is provided to face forward of the display panel 1 (upwardly in FIG. 7(a)), and is provided to be tilted relative to the light collecting surface 8a by an acute angle (for example, 60°). The light shielding surface 8b is formed by applying a light shielding coating to, for example, the translucent light guiding member 8 such that the light shielding surface 8b prevents light from entering into the light guiding member 8.

By providing the light guiding member 8 to the opening of the recess 2c of the framing member 2a, the outgoing light from the screen 1a of the display panel 1 and the extraneous light reflected on the screen 1a are allowed to enter the light guiding member 8 through the light collecting surface 8a, which is provided in parallel with the screen 1a. Thus, it is possible to guide light to the light receiving surface 5a of the optical sensor 5, which is provided within the recess 2c (see the solid line arrow in FIG. 7(b)). Also, extraneous light, which is directly applied from the exterior to the light guiding member 8, is prevented by the light shielding surface 8b, and does not enter into the light guiding member 8. Thereby, the extraneous light is not received by the light receiving surface 5a of the optical sensor 5.

### Fourth Embodiment

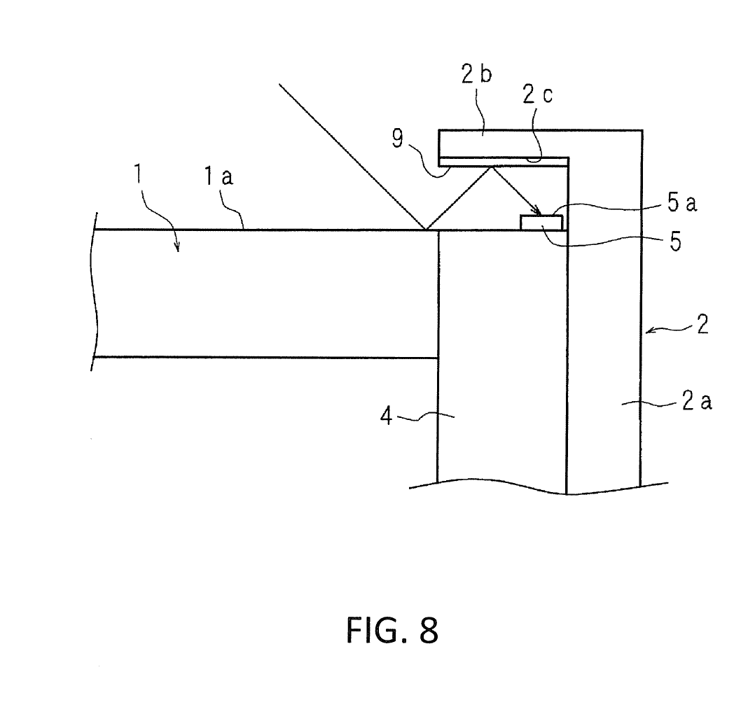

FIG. 8 is a schematic cross-sectional view illustrating a configuration of a display device 100 according to the fourth embodiment of the present invention. The display device 100 according to the fourth embodiment includes a mirror 9 that guides light to the light receiving surface 5a of the optical sensor 5, which is provided within the recess 2c. The optical sensor 5 is provided within the recess 2c such that the light receiving surface 5a faces in the direction, in which the screen 1a of the display panel 1 faces. In other words, the light receiving surface 5a faces forward of the display device 100. The optical sensor 5 is provided into the back of the recess 2c such that extraneous light, which has directly entered into the recess 2c, is not received by the light receiving surface 5a.

The mirror 9 is provided to face the screen 1a of the display panel 1 and the light receiving surface 5a of the optical sensor 5 (or in other words, the mirror 9 is provided to face backward of the display device 100), and is provided to the inner surface of the recess 2c generally in parallel with the screen 1a and the light receiving surface 5a. Due to the above, extraneous light, which has directly entered into the recess 2c, is not received nor reflected on the mirror 9. On the other hand, outgoing light from the screen 1a of the display panel 1 and extraneous light reflected on the screen 1a (see the solid line arrow in FIG. 8) enter into the mirror 9 in the recess 2c, and are reflected toward the light receiving surface 5a of the optical sensor 5 to be received by the light receiving surface 5a.

In the above embodiments, the optical sensor 5 is provided at the position where the optical sensor 5 is prevented from overlapping the screen 1a. However, if the optical sensor 5 is small enough not to influence the display of the image for the work of the user even when the optical sensor 5 is provided to face the screen 1a, it is not necessarily provide the optical sensor 5 at the position where the optical sensor 5 is prevented from overlapping the screen 1a. In the above embodiments, since the optical sensor 5 does not overlap the screen 1a, it is possible to further improve the workability of the user.

In the above embodiments, the liquid crystal panel is employed as a display unit of the display device. However, the display unit is not limited to the liquid crystal panel. The present invention may be applicable to other display devices, such as an organic EL, a CRT, a PDP, etc.

In the above embodiments, the measurement of the light or the color is executed while the image for the work of the user remains displayed as it is. However, the luminance or an RGB gain in the measurement area MA may be changed to an extent such that the user is unable to recognize the change, or may be changed at the timing when the user is unable to recognize the change.

In the above embodiments, both of the luminance and the chromaticity are measured and adjusted. However, the configuration is not limited to the above. Alternatively, one of the luminance and the chromaticity may be measured and adjusted.

In the above embodiments, a color monitor is employed. However, the configuration is not limited to the above. The present invention may be also applicable to a monochrome monitor. In the above case, the configuration related to the color adjustment is not required.

In the above embodiments, the display device solely executes series of process. However, the configuration is not limited to the above. Computer programs for executing the similar process may be installed on a personal computer, which is connected to the display device, and the personal computer may execute a part of the process.

Although a few embodiments of the present invention have been shown and described, it would be appreciated by those skilled in the art that changes may be made in this embodiment without departing from the principles and spirit of the invention, the scope of which is defined in the claims and their equivalents.

1. A display device having a display panel that displays an image, comprising:
a measurement unit that measures a light intensity from a partial display area of the display panel, the partial display area having a plurality of pixels;
a computation unit that computes the light intensity emanating from the display area based on image data for displaying an image in the display area;
a comparison unit that compares the light intensity computed by the computation unit with the light intensity measured by the measurement unit; and
an adjustment unit that adjusts the light intensity of the display panel based on a comparison result by the comparison unit.

2. The display device according to claim 1, further comprising:
a pixel intensity computation unit that computes the light intensity emanating from each of the pixels in the display area based on the image data for displaying the image in the display area, wherein:
the computation unit is configured to compute the light intensity based on a value computed by summing the light intensity, which is computed by the pixel intensity computation unit, of each of the pixels in the display area.

3. The display device according to claim 2, further comprising:
a weighting unit that weights the light intensity, which is computed by the pixel intensity computation unit, according to each of the pixels in the display area, wherein:
the computation unit is configured to compute the light intensity based on a value computed by summing the light intensity, which is weighted by the weighting unit, of each of the pixels in the display area.

4. The display device according to claim 3, wherein:
the weighting unit is configured to weight the light intensity based on a distance of each of the pixels in the display area from the measurement unit.

5. The display device according to claim 4, wherein:
the weighting unit is configured to weight the light intensity based on an angle formed between each of the pixels in the display area and the measurement unit.

6. The display device according to claim 1, wherein:
the measurement unit is located at a position where the measurement unit is prevented from overlapping a screen of the display panel.

7. The display device according to claim 1, wherein the light intensity includes at least one of luminance and chromaticity.

8. A computer program for adjusting a light intensity from a display panel that displays an image, causing a computer to execute steps of:
measuring a light intensity from a partial display area of the display panel;
computing the light intensity emanating from the display area based on image data for displaying an image in the display area;
comparing the computed light intensity with the measured light intensity; and
adjusting the light intensity of the display panel based on a comparison result at the comparing step.

9. A computer readable storage medium that stores the computer program according to claim 8.

10. An image displaying method of a display device having a display panel that displays an image, comprising steps of:
measuring a light intensity from a partial display area of the display panel by using a measurement unit, the partial display area having a plurality of pixels;
computing the light intensity emanating from the display area based on image data for displaying an image in the display area;
comparing the computed light intensity with the measured light intensity; and
adjusting the light intensity of the display panel based on a comparison result at the comparing step by using an adjustment unit.

11. The display device according to claim 2, wherein:
the measurement unit is located at a position where the measurement unit is prevented from overlapping a screen of the display panel.

12. The display device according to claim 3, wherein:
the measurement unit is located at a position where the measurement unit is prevented from overlapping a screen of the display panel.

13. The display device according to claim 4, wherein:
the measurement unit is located at a position where the measurement unit is prevented from overlapping a screen of the display panel.

14. The display device according to claim 5, wherein:
the measurement unit is located at a position where the measurement unit is prevented from overlapping a screen of the display panel.

15. The display device according to claim 2, wherein the light intensity includes at least one of luminance and chromaticity.

16. The display device according to claim 3, wherein the light intensity includes at least one of luminance and chromaticity.

17. The display device according to claim 4, wherein the light intensity includes at least one of luminance and chromaticity.

18. The display device according to claim 5, wherein the light intensity includes at least one of luminance and chromaticity.

19. The display device according to claim 6, wherein the light intensity includes at least one of luminance and chromaticity.
